(19) United States
(12) Patent Application Publication
(10) Pub. No.: US 2025/0051503 A1
(43) Pub. Date: Feb. 13, 2025

(54) alpha-OLEFIN MALEIC ACID OR MALEIMIDE COPOLYMERS FOR ENHANCED BIOACTIVITY

(71) Applicant: UNIVERSITY OF TENNESSEE RESEARCH FOUNDATION, Knoxville, TN (US)

(72) Inventors: Brian LONG, Knoxville, TN (US); Nathan G. BRADY, Knoxville, TN (US); Barry D. BRUCE, Knoxville, TN (US); Cameron Edward Workman, Knoxville, TN (US)

(73) Assignee: UNIVERSITY OF TENNESSEE RESEARCH FOUNDATION, Knoxville, TN (US)

(21) Appl. No.: 18/717,548

(22) PCT Filed: Dec. 8, 2022
(86) PCT No.: PCT/US2022/081181

§ 371 Date: Jun. 7, 2024

Related U.S. Application Data
(60) Provisional application No. 63/265,116, filed on Dec. 8, 2021.

(51) Int. Cl. C08F 222/02; C08F 222/40

(52) U.S. Cl. CPC C08F 222/02; C08F 222/402

(57) ABSTRACT

α-Olefin maleic acid copolymers and α-olefin-co-maleimide copolymers have the CH₂—CH of the α-olefin in the backbone of the copolymer with the maleic acid or maleimide and the remainder thereof extending from the backbone. The α-olefin having the formula CH₂— CH—(CH₂)_{X}-R¹, and x being in the range of 1 to 19, y and z have a ratio in a range of 0.25: 1 to 8: 1, and n R¹ yields a copolymer having an average molecular weight of less than 500 kg/mol. R¹ (and R² in the case of the α-olefin-co-maleimide copolymers) is/are selected from a diverse group of moieties. The α-olefin maleic acid copolymers and α-olefin-co-maleimide copolymers each form lipid particles where the lipid can be from a galactolipid rich membrane of a cyanobacterium.

### RELATED APPLICATIONS

This application claims the benefit of U.S. Provisional Application No. 63/265,116, filed Dec. 8, 2021, the entirety of which is incorporated herein by reference.

### TECHNICAL FIELD

This application relates to α-olefin maleic acid copolymers and α-olefin-co-maleimide copolymers, more particular, to said copolymers having a terminal R¹ group on the α-olefin, where R¹ of the copolymer typically has a structure that does not provide UV absorbace (i.e., does not interference with certainer characterization techniques).

### BACKGROUND

Membrane proteins are prolific targets for the design, development, and targeted delivery of pharmaceuticals. Over 60% of all currently available drugs target membrane proteins to accomplish their therapeutic effect. However, membrane proteins remain the least characterized class of all proteins, with only ˜2% of all protein structures having been solved. One of the primary reasons for this low number of solved protein structures is that many membrane proteins lose their native conformation when extracted using conventional methods (e.g. detergents), convoluting accurate structure determination. In contrast, amphiphilic styrene-maleic acid copolymers (SMAs) were recently discovered to readily isolate membrane proteins via the formation of stable “nanodiscs” that contain an annulus of retained native lipids. These nanodiscs, commonly referred to as styrene-maleic acid lipid particles (SMALPs), have been shown to retain the proteins native conformation and facilitate precise structural characterization using methods such as cryogenic electron microscopy, which can then inform future drug development efforts.

Over the past decade, styrene-maleic acid copolymers (SMAs) have become widely used for the solubilization of membrane proteins. Diisobutylene-maleic acid copolymers (DIBMAs) likewise have been studied for their ability to solubilize membrane proteins. Their unique ability to form styrene-maleic acid lipid particles (SMALPs) and Diisobutylene maleic acid lipid particles (DIBMALPs), which are polymer bound nanodiscs comprised of protein within an annulus of retained native lipids, has made these amphiphilic copolymers the subject of numerous investigations. Salient reports include studies designed to understand how various SMA molecular characteristics and DIBMA molecular characteristics play into SMALP formation and efficacy of these polymers in protein extraction. For example, it has been shown in literature that both the molecular weight of the polymer and the incorporation ratio of the monomeric units are both crucial parameters in this process.

Despite these advances, little is known about the mechanism of SMA-facilitated protein extraction and solubilization. Many studies designed to probe this mechanism have shown that altering the chemical composition of SMA can result in characteristic changes in nanodisc formation. Examples of such investigations include studies by Ramamoorthy and coworkers in which the maleic anhydride repeating units of SMA copolymers were converted into maleimides bearing quaternary ammonium pendant groups, increasing the polymer's tolerance to divalent cations and low pH. Ravula et al., pH Tunable and Divalent Metal Ion Tolerant Polymer Lipid Nanodiscs. Langmuir 2017, 33 (40), 10655-10662. In another study, Konkolewicz and Lorigan achieved a similar result by performing esterification and amidation reactions on SMAs using a variety of moieties, ranging from glucose to 2-aminothanol. Burridge et al., Simple Derivatization of RAFT-Synthesized Styrene-Maleic Anhydride Copolymers for Lipid Disk Formulations. Biomacromolecules 2020, 21 (3), 1274-1284. Overduin and coworkers showed that SMA functionalization can be used to manipulate the size of resulting SMALPs, further highlighting how functionalized SMA samples can be utilized to alter various aspects of the protein extraction process. Esmaili et al., The effect of hydrophobic alkyl sidechains on size and solution behaviors of nanodiscs formed by alternating styrene maleamic copolymer, Biochimica et Biophysica Acta (BBA) -Biomembranes 2020, 1862 (10), 183360. Though all of these studies demonstrate the effects of SMA functionalization, they do not investigate how SMA functionalization alters extraction efficiency or selectivity in specific protein solubilization trials. An understanding of the fundamental relationships between specific SMA derivatization and the resultant extraction selectivity and/or efficiency could facilitate the selection and design of SMAs with enhanced extraction yields, as well as the potential to target specific proteins.

Several of the inventors hereof have recently shown that certain commercially available SMA-based copolymers exhibit the ability to form SMALPs from chloroplast thylakoid membranes, which is of note due to a lack of studies investigating galactolipid rich membranes of cyanobacterial thylakoid membranes. Korotych et al., Poly(styrene-co-maleic acid)-mediated isolation of supramolecular membrane protein complexes from plant thylakoids, Biochimica et Biophysica Acta (BBA)-Bioenergetics 2021, 1862 (3), 148347. The commercially available SMA studies was SMA 1440 (Cray Valley, now available from Polyscope), a 1.5:1 styrene:maleic acid copolymer that is monoesterified with butoxyethanol allegedly to 72% monoesterification (36% total esterification), appears to selectively extract the Photosystem I (PSI) trimer from the thylakoid membranes of Thermosynechococcus elongatus (Te), whereas the most widely used SMA copolymers, those containing a 2:1 ratio of styrene:maleic acid, are ineffective at solubilizing thylakoid membranes from Te. Brady et al., Non-detergent isolation of a cyanobacterial photosystem I using styrene maleic acid alternating copolymers. RSC Advances 2019, 9 (54), 31781-31796.

In co-pending PCT/US22/28113, the inventors hereof detailed how the functionalization of SMA-based copolymers with alkoxy ethoxylate sidechains can drastically increase the quantity of trimeric photosystem I complexes (PSI) extracted from the cyanobacterium, Thermosynechococcus elongatus (Te), as well as increase extraction selectivity for this particular membrane protein complex. While alkoxy ethoxylate functionalized SMA analogs (F-SMAs) exhibit high solubilization efficiencies and selectivity in the extraction of PSI from Te, they also have some negative attributes. For instance, F-SMAs can lose large degrees of esterification during base-catalyzed solubilization via deleterious saponification side reactions. In addition, F-SMAs also contain styryl units which absorb UV light, making some protein characterization techniques difficult.

There is a need for functionalized SMAs that have high increased bioactivity without the negative attributes discussed above.

### SUMMARY

To remove the negative attributes discussed above, amphiphilic copolymers were created in which the hydrophobic styryl units were replaced with long alkyl moieties. The resulting α-olefin-co-maleic acid copolymers (αMAs) and α-olefin-co-maleimide copolymers (αMIs) exhibit bioactivity for the extraction of membrane proteins from the thylakoid membranes of Te. In addition, αMAs and αMIs can be quickly synthesized and are easily purified. Also, the αMAs and αMIs are not as susceptible to degradation via saponification. Finally, some of the αMAs and αMIs have no UV absorbing chemical groups, in particular in the R¹ position.

In one aspect, modified maleic acid copolymers herein are of a general formula I

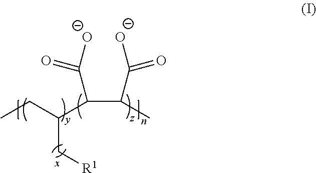

wherein x is in a range of 1 to 19; y and z have a ratio in a range of 0.25:1 to 8:1; n yields a copolymer having an average molecular weight of less than 500 kg/mol; and R¹ is selected from the group consisting of
i. a linear alkane chain, optionally, containing or terminating with a cyclic carbon,
ii. a linear chain alkoxy alkane of the formula —(CH₂)_{q}O(CH₂)ᵣCH₃ where q is 1 to 5 and r is 1 to 15,
iii. an alkoxy alkane containing or terminating with a cyclic carbon chain,
iv. a halogenated alkane,
v. a halogenated cycloalkane,
vi. a halogenated arene,
vii. a chain containing a repeating sequence of (CH₂CH₂O)ₜ terminating with —OR² wherein t equals a value of 1 to 50 and R² is hydrogen, a linear alkane, a cyclic alkane, a trifluoromethyl, a halogenated alkane, a halogenated cycloalkane, or a halogenated arene,
viii. a hydrogen, and
ix. mixtures thereof.

In all embodiment, y and z can have a ratio of 1:1.2.

In one embodiment, x is 5, 7, 9, 11, or 13, more particularly x is 11 and R¹ is a methyl and the average molecular weight is greater than 2 kg/mol but less than 6 kg/mol.

In one embodiment, R¹ is one or more of a methyl, a cyclohexane, a benzyl, a norbornyl, or a trifluormethyl group.

In another aspect, the copolymer, instead of having a maleic acid, can be reacted with a nitrogen compound to be in the form of a maleimide. The α-olefin-co-maleimide copolymer (αMI) is one according to the general formula II below.

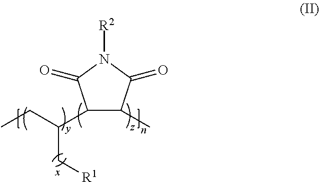

wherein x is in a range of 1 to 19; y and z have a ratio in a range of 0.25:1 to 8:1; n yields a copolymer having an average molecular weight of less than 500 kg/mol; and R¹ and R² are both selected from the same group consisting of i to ix listed above and R¹ and R² are the same or different.

In yet another aspect, α-olefin maleic acid copolymer lipid particles herein have a lipid from a phospholipid rich membrane or a galactolipid rich membrane and α-olefin maleic acid copolymer of any of the chemical structures disclosed herein. In one embodiment, the lipid is from a galactolipid rich membrane of a cyanobacterium, which can be Thermosynechococcus elongatus.

In yet another aspect, α-olefin-co-maleimide copolymer lipid particles herein have a lipid from a phospholipid rich membrane or a galactolipid rich membrane and α-olefin-co-maleimide copolymer of any of the chemical structures disclosed herein. In one embodiment, the lipid is from a galactolipid rich membrane of a cyanobacterium, which can be Thermosynechococcus elongatus.

### BRIEF DESCRIPTION OF THE DRAWINGS

FIG. 1 is an illustrative representation of αMA extraction of proteins from a PSI lipid membrane.

FIG. 2 is a graph showing a comparison of percent solubilization efficiency (SE) of chlorophyll-containing pigment-protein complexes from a thylakoid membrane for various αMAs as a function of polymer concentration.

FIG. 3 is a bar graph of a molecular weight study of various αMAs and of differing number average molecular weight (M) and dispersity for effect of solubilization efficiency.

FIG. 4 is the chemical structure of an α-olefin maleic anhydride copolymer having the α-olefin terminate with a hexane ring.

FIG. 5 is the chemical structure of an α-olefin maleic anhydride copolymer having the α-olefin terminate with a benzene ring.

FIG. 6 is the chemical structure of an α-olefin maleic anhydride copolymer having the α-olefin terminate with a norbornyl unit.

FIG. 7 is the chemical structure of an α-olefin maleic anhydride copolymer having the α-olefin terminate with a trifluoromethyl group.

FIG. 8 is a photograph of test tubes bearing the restuls of sucrose density gradients of PSI-αMALPs of the various α-olefin maleic anhydride copolymers tested as compared to a DDM SMALP.

FIG. 9A is a TEM micrograph of PSI-Trimer αMALPs made with C₁₄MA^{1.8}.

FIG. 9B is a TEM micrograph of PSI-Trimer αMALPs made with C₁₄MA^{4.8}.

FIG. 9C is a TEM micrograph of PSI-Trimer αMALPs made with C₁₄MA^{5.6}.

FIG. 10 is a graph of absorbance versus wavelength for PSI-C₁₄MALPs. of verious Mₙ.

FIG. 11 is a graph of flourescence versus wavelength for PSI-C₁₄MALPs. of verious Mₙ.

FIG. 12 is a photograph of results for SDS-PAGE of PSI-C₁₄MALPs.

FIG. 13 is a photograph of results for BN-PAGE of PSI-C₁₄MALPs.

FIG. 14 is a graph of dynamic light scattering data for PSI-C₁₄MALPs.

FIG. 15 is the chemical structure of an α-olefin-co-maleimide copolymer.

FIG. 16 is the chemical structure of an α-olefin maleic anhydride copolymer having the α-olefin terminate with a hexane ring.

FIG. 17 is the chemical structure of an α-olefin maleic anhydride copolymer having the α-olefin terminate with a benzene ring.

FIG. 18 is the chemical structure of an α-olefin maleic anhydride copolymer having the α-olefin terminate with a norbornyl unit.

FIG. 19 is the chemical structure of an α-olefin maleic anhydride copolymer having the α-olefin terminate with a trifluoromethyl group.

### DETAILED DESCRIPTION

The following description and drawings are illustrative and are not to be construed as limiting. Numerous specific details are described to provide a thorough understanding of the disclosure. In certain instances, however, well-known or conventional details are not described to avoid obscuring the description. References to one or an embodiment in the present disclosure can be, but not necessarily, are references to the same embodiment; and, such references mean at least one of the embodiments.

Unless otherwise noted, technical terms are used according to conventional usage. Definitions of common terms in molecular biology may be found in Benjamin Lewin, Genes IX, published by Jones and Bartlet, 2008 (ISBN 0763752223); Kendrew et al. (eds.), The Encyclopedia of Molecular Biology, published by Blackwell Science Ltd., 1994 (ISBN 0632021829); and Robert A. Meyers (ed.), Molecular Biology and Biotechnology: a Comprehensive Desk Reference, published by VCH Publishers, Inc., 1995 (ISBN 9780471185710) and other similar references. As used herein, the singular forms “a,” “an,” and “the,” refer to both the singular as well as plural, unless the context clearly indicates otherwise. The abbreviation, “e.g.” is derived from the Latin exempli gratia and is used herein to indicate a non-limiting example. Thus, the abbreviation “e.g.” is synonymous with the term “for example.” As used herein, the term “comprises” means “includes.” All publications, patent applications, patents, and other references mentioned herein are expressly incorporated herein by reference in their entirety.

“Isolated” as used herein refers to biological proteins that are removed from their natural environment and are isolated or separated and are free from other components with which they are naturally associated. The term “purified” does not require absolute purity; rather, it is intended as a relative term. Thus, for example, a purified or “substantially pure” protein preparation is one in which the protein referred to is more pure than the protein in its natural environment within a cell or within a production reaction chamber (as appropriate).

As used herein, relative terms, such as “substantially,” “generally,” “approximately,” “about,” and the like are used herein to represent an inherent degree of uncertainty that can be attributed to any quantitative comparison, value, measurement, or other representation. These terms are also utilized herein to represent the degree by which a quantitative representation can vary from a stated reference without resulting in a change in the basic function of the subject matter at issue. In certain example embodiments, the term “about” is understood as within a range of normal tolerance in the art for a given measurement, for example, such as within 2 standard deviations of the mean. In certain example embodiments, depending on the measurement “about” as used herein means said value ±3 when the value is expressed as a percentage and +5% of a value when expressed as or based on a measurement and it is not a percentage. Unless otherwise clear from context, all numerical values provided herein can be modified by the term about. “Substantially free” or “free” besides the values just stated, can be almost zero or zero, respectively.

In one aspect, α-olefin maleic acid copolymers (αMA) of general formula I, i.e., α-olefin maleic acid copolymers, are disclosed.

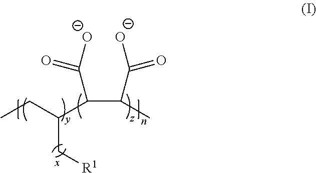

wherein x is in a range of 1 to 19; y and z have a ratio in a range of 0.25:1 to 8:1; n yields a copolymer having an average molecular weight of less than 500 kg/mol; and R¹ is selected from the group consisting of
i. a linear alkane chain, optionally, containing or terminating with a cyclic carbon,
ii. a linear chain alkoxy alkane of the formula —(CH₂)_{q}O(CH₂)ᵣCH₃ where q is 1 to 5 and r is 1 to 15,
iii. an alkoxy alkane containing or terminating with a cyclic carbon chain,
iv. a halogenated alkane,
v. a halogenated cycloalkane,
vi. a halogenated arene,
vii. a chain containing a repeating sequence of (CH₂CH₂O)ₜ terminating with —OR² wherein t equals a value of 1 to 50 and R² is hydrogen, a linear alkane, a cyclic alkane, a trifluoromethyl, a halogenated alkane, a halogenated cycloalkane, or a halogenated arene,
viii. a hydrogen, and
ix. mixtures thereof.

Formula I is represented with carboxylate units (—O—) for the maleic acid portion of the copolymer. A general counterion X⁺ can be present to balance the negative charge of the carboxylate units. X⁺ can be selected from the group consisting of ammonium, lithium, sodium, and potassium ions, but is not limited thereto.

Since the αMA has numerous y units, R¹ can be a mixture of moietys listed above. In one embodiment, R¹ is the same for all units. In another embodiment, there are two different moietys present for R¹ and they have a random distribution along the polymer. In another embodiment, there are three different moietys present for R¹ and they can have a random distribution along the polymer. In one embodiment, a portion of the R¹ groups are hydrogen and a portion of the R¹ groups are a linear alkane chain. In another embodiment, a portion of the R¹ groups are hydrogen and a portion of the R¹ groups are a halogenated cycloalkane. These are just two examples of possible combinations of i to viii, which are not meant to be limiting. It is understood that “and mixtures thereof” encompasses all possible combination of i to viii for selections of two, three, four, five, six, seven or even all eight thereof.

R¹ can be a linear alkane chain. The alkane chain can have 1 to 19 carbons, and optionally terminates with or containing a cyclic carbon chain, such as a cycloalkane or cyclic ether. In one embodiment, the linear alkane chain can be based on a methane, ethane, propane, butane, pentane, hexane, heptane, octane, nonane, decane, or any combination thereof dispersed on the polymer. In some embodiments, the linear alkane chane has 5, 7, 9, 11, or 15 carbons.

R¹ can be a linear chain alkoxy alkane of the formula —(CH₂)_{q}O(CH₂)ᵣCH₃ where q is 1 to 5 and r is 1 to 15. This linear chain alkoxy alkane can terminate with or contain a cycloalkane in the r segment.

R¹ can be a halogenated alkane. The alkane chain can have 1 to 19 carbons and be fully or partially halogenated. The halogen can be a fluoro, chloro, bromo, or iodo group. In one embodiment, the linear alkane chain can be based on a methane, ethane, propane, butane, pentane, hexane, heptane, octane, nonane, decane, or any combination thereof dispersed on the polymer. In one embodiment, at least some of the R¹ groups on the polymer are a trifluoromethyl, trichloromethyl, tribromomethyl, or triiodomethyl.

R¹ can be a halogenated cycloalkane. The cycloalkane can have 3 to 12 carbons in the ring and can be fully or partially halogenated. The halogen can be a fluoro, chloro, bromo, or iodo group.

R¹ can be a halogenated arene. The arene can have 1 to 4 fused or aromatic rings and can be fully or partially halogenated. For example, the halogenated arene has 1 benzene ring, 2 fused aromatic rings (i.e., a napthalene structure with one or more halogens), or 3 fused aromatic rings (i.e., an anthracene structure with one or more halogens).

R¹ can be a chain containing a repeating sequence of (CH₂CH₂O)ₜterminating with —OR², the copolymer is monoesterified with greater than 20% total esterification, and t=1 to 50. R² can be hydrogen, any linear alkane, or cyclic alkane. When R² is a linear alkane, the number of carbon atoms can be 1 to 16. When R² is a cyclic alkane, the number of carbon atoms in the ring is 3 to 12. Several examples are diethylene glycol, triethylene glycol, tetraethylene glycol, pentaethylene glycol, and hexaethylene glycol. In an embodiment where —OR¹ is diethylene glycol and the copolymer is greater than 50% monoesterified, the functionalized copolymer is stable in aqueous solution at a pH greater than 5.0 and at a magnesium ion concentration up to 50 mM. In an embodiment where R¹ is tetraethylene glycol and the copolymer is greater than 40% monoesterified, the functionalized copolymer is stable in aqueous solution at a pH greater than 5.0 and at a magnesium ion concentration up to 100 mM.

In one embodiment, R¹ comprises the linear alkane chain and/or the linear chain alkoxy alkane, which can be partially or fully halogenated or partially or fully deuterated. Likewise, if a cyclic carbon chain is present on either of the linear alkane chain and/or the linear chain alkoxy alkane, the carbons here can also be partially or fully halogenated or partially or fully deuterated.

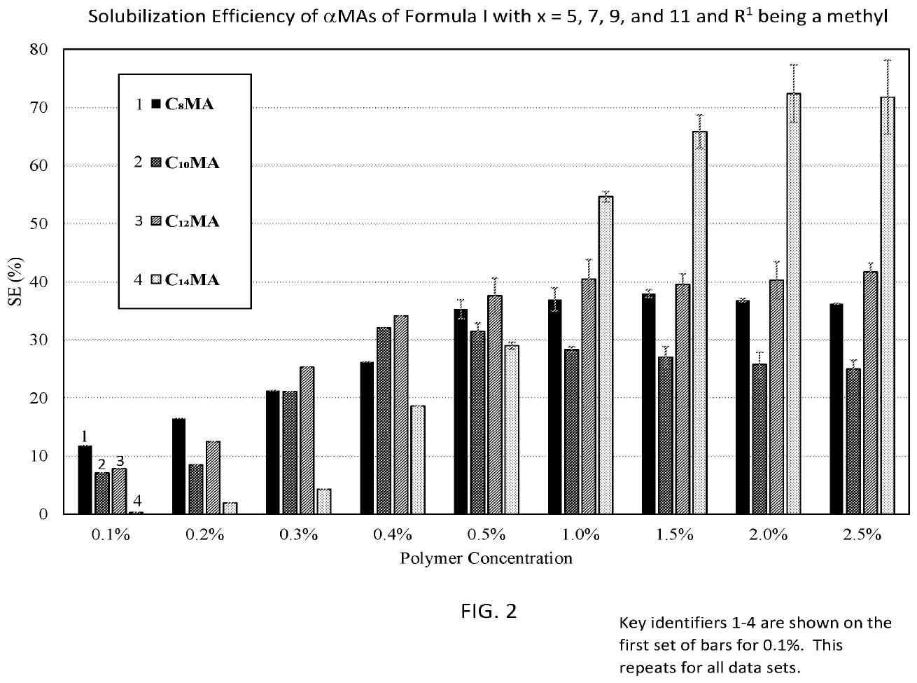

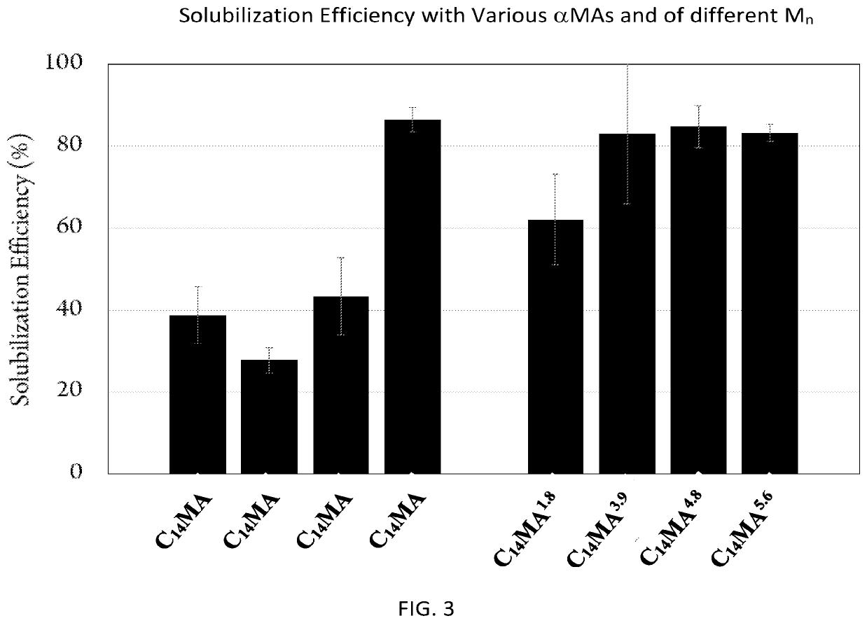

The α-olefin maleic acid copolymers are generally unlimited in the ratio of y to z and in the size of n, which determines the molecular weight thereof. The average molecular weight (Ma) will typically be less than 500 kg/mol, more particularly less than 250 kg/mol, and even further less than 100 kg/mol. In some embodiments, the average molecular weight is less than 10 kg/mol. M_{w}/Mₙ (M_{w}being the weight average molecular weight and Mₙ being the number average molecular weight) indicates the dispersity (D), and will typically be less than 7, more particularly less than 3, or even less than 2. In all the embodiments, the dispersity can be between 1 and 2, more preferably in a range of 1.1 to 1.8. In the working examples presented in FIGS. 2 and 3 for tetradecane-maleic anhydride copolymers, the dispersity is 1.3, 1.4, or 1.6 and the Mₙ are in a range of 1.8 kg/mol to 5.6 kg/mol.

The y to z monomer ratio, i.e., the ratio of α-olefin to maleic acid, can be in a range of 0.25:1 to 8:1. Exemplary monomer ratios herein are typically less than or equal to 1:1 and may include but are not limited to 1: 1.1, 1:1.2, 1:1.3, 1:1.5, 1:2, 1:2.5, 1:3, 1:3.5, 1:4, 1:4.5, 1:6.

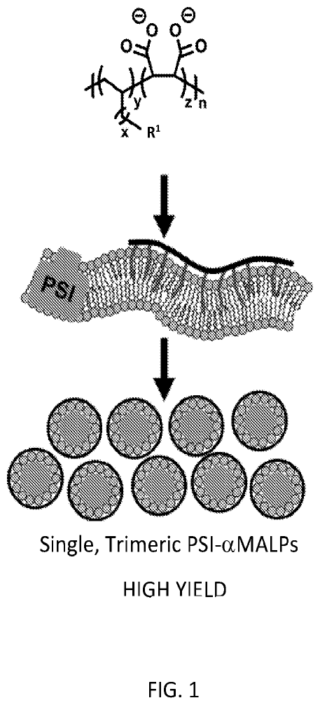

The α-olefin maleic acid copolymers disclosed herein are useful for extracting lipids from membranes that are lipid-rich in the form a nanodisc shaped lipid particles. A representation of a αMA lipid particle is provided in FIG. 1 hereof and FIG. 1 of Applicant's co-pending U.S. application Ser. No. 17/594,503, filed on Oct. 20, 2021 is a representation of a styrene maleic acid copolyer lipid particle (SMALP).

Lipids suitable for extraction from biomolecules using the modified maleic acid copolymers disclosed herein will typically be membrane forming lipids. Membrane forming lipids comprise a diverse range of structures including galactolipids, phospholipids (some examples include the glycerophosholipids such as phosphatidylcholine, phosphatidylethanolamine, phosphatidylglycerol, phosphatidylinositol, phosphatidylserine, and cardiolipin; ether glycerol[ids such as plasmalogens and platelet activating factor), sphingolipis (some examples includes glycolipids such as cerebrosides, sulfatides, globosides, gangliosides, and other examples include sphingophospholipids susch as sphingomyelin), and ceramides, and among others. Membrane forming lipids typically have a polar head group (which in a membrane aligns towards the aqueous phase) and one or more hydrophobic tail groups (which in a membrane associate to form a hydrophobic core). The hydrophobic tail groups will typically be in the form of acyl esters, which may vary both in their length (typically from 8 to 26 carbon atoms) and their degree of unsaturation (number of multiple bonds present). Phosphatidylcholine (PtdCho) and phosphatidylethanolamine (PtdEtn) heads are zwitterionic, whereas phosphatidylserine (PtdSer) and phosphatidylinositol (PtdIns) heads are anionic.

Sphingolipids (SL) contain one hydrophobic acyl chains and a phosphate head group ester linked to a Sph backbone. Their hydrophobic backbone is an ester or amide derivative of Sph with fatty acids being ceramide (Cer) the simplest representative. Sphingomyelin (SM) contains a phosphorylcholine headgroup associated to the sphingoid base. SM is the more abundant SL in the plasma membrane (PM) of mammalian cells. Within the total PL fraction of the PM, SM accounts for 2%-15% upon the cell type. Other SLs are glycosphingolipids (GSLs). GSLs are based on glucosylceramide (GlcCer) or on galactosylceramide (GalCer) and contain mono-, di- or oligosaccharides. Sphingolipids are defined by the presence of a sphingoid-base backbone (i.e., 2-aminoalk[ane or ene]1,3-diol with 2S,3R stereochemistry). The main feature that allows the formation of an impermeable lipid bilayer is the amphipathic nature of these molecules, resulting in a highly hydrophobic core and hydrophilic surface, the landmark of biological and model membranes.

Lipids suitable for extraction from biomolecules using the modified maleic acid copolymers disclosed herein may be of natural or synthetic origin, and may be a single pure component (e.g., 90% pure, especially 95% pure and suitably 99% pure on a weight basis), a single class of lipid components (for example, a mixture of phosphatidylcholines, or alternatively, a mixture of lipids with a conserved acyl chain type) or may be a mixture of many different lipid types. A single pure lipid is generally of synthetic or semi-synthetic origin. Examples of pure lipids include phosphatidylcholines and phosphatidylglycerols.

Mixtures of lipids are more typically of natural origin, obtained by extraction and purification by means known to one of skill in the art. Exemplary lipid extracts include: Epikuron 200 available from Degussa Texturant Systems UK Ltd; Emulmetik 950, Emulmetik 930, Pro-Lipo H and Pro-Lipo Duo available from Lucas Meyer Cosmetics SA; Liposome 0041, S 75, S 100, S PC, SL 80 and SL 80-3 available from Lipoid GmbH; Phospholipon® 90H, Phospholipon® 80H, Phospholipon® 90 NG, Nat 8539 available from Phospholipid GmbH. Lipid extracts of plant origin may typically be expected to demonstrate higher levels of unsaturation as compared to those of animal origin. It should be noted that, due to variation in the source, the composition of lipid extracts may vary from batch to batch.

In another aspect, the copolymer, instead of having a maleic acid, can be reacted with a nitrogen compound to be in the form of a maleimide. The α-olefin-co-maleimide copolymer (αMI) is one according to the general formula II below.

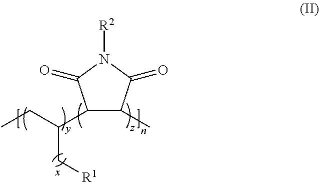

wherein x is in a range of 1 to 19; y and z have a ratio in a range of 0.25:1 to 8:1; n yields a copolymer having an average molecular weight of less than 500 kg/mol; and R¹ and R² are both selected from the group consisting of
i. a linear alkane chain, optionally, containing or terminating with a cyclic carbon,
ii. a linear chain alkoxy alkane of the formula —(CH₂)_{q}O(CH₂)ᵣCH₃ where q is 1 to 5 and r is 1 to 15,
iii. an alkoxy alkane containing or terminating with a cyclic carbon chain,
iv. a halogenated alkane,
v. a halogenated cycloalkane,
vi. a halogenated arene,
vii. a chain containing a repeating sequence of (CH₂CH₂O)ₜ terminating with —OR² wherein t equals a value of 1 to 50 and R² is hydrogen, a linear alkane, a cyclic alkane, a trifluoromethyl, a halogenated alkane, a halogenated cycloalkane, or a halogenated arene,
viii. a hydrogen, and
ix. mixtures thereof, and
   R¹ and R² are the same or different.

Since the αMI has numerous y units, one or both of R¹ and R² can be a mixture of the moietys listed above. In one embodiment, R¹ is the same for all units and R² is the same for all units, which in one embodiment are the same (i.e., R¹=R²) and in another embodiment are different (i.e., (R¹ ≠R²). In yet another embodiment, there are two different moietys present for R¹ and they have a random distribution along the copolymer and R² is different from R¹, but is the same throughout the copolymer. In still another embodiment, there are two different moietys present for R¹ and they have a random distribution along the copolymer and the same two different moietys are present for R² and they have a random distribution along the copolymer. In another embodiment, there are three different moietys present for R¹ and they can have a random distribution along the polymer, and R² can have a single moeity through, a mixture of two moietys randomly dirstubted along the copolymer, or can have the same three moeities as R¹ which are randomly distributed along the copolymer. In one embodiment, a portion of the R¹ groups are hydrogen and a portion of the R¹ groups are a linear alkane chain. In another embodiment, a portion of the R¹ groups are hydrogen and a portion of the R¹ groups are a halogenated cycloalkane. These are just two examples of possible combinations of i to viii, which are not meant to be limiting. It is understood that “and mixtures thereof” encompasses all possible combination of i to viii for selections of two, three, four, five, six, seven or even all eight thereof for both of R¹ and R² individually or simulataneously.

Examples for i to viii are discussed above with respect to general formula I, so the information is not repeated again, but is understood to be equally applicable to general formula II.

The α-olefin maleic acid copolymers are generally unlimited in the ratio of y to z and in the size of n, which determines the molecular weight thereof. The average molecular weight (Ma) will typically be less than 500 kg/mol, more particularly less than 250 kg/mol, and even further less than 100 kg/mol. In some embodiments, the average molecular weight is less than 10 kg/mol. M_{w}/Mₙ (M_{w}being the weight average molecular weight and Mₙ being the number average molecular weight) indicates the dispersity (D), and will typically be less than 7, more particularly less than 3, or even less than 2. In all the embodiments, the dispersity can be between 1 and 2 and the Mₙ are in a range of 1.8 kg/mol to 5.6 kg/mol.

The y to z monomer ratio, i.e., the ratio of α-olefin to maleimide, can be in a range of 0.25:1 to 8:1. Exemplary monomer ratios herein are typically less than or equal to 1:1 and may include but are not limited to 1:1.1, 1:1.2, 1:1.3, 1:1.5, 1:2, 1:2.5, 1:3, 1:3.5, 1:4, 1:4.5, 1:6.

The α-MI disclosed herein are useful for extracting lipids from membranes that are lipid-rich in the form a nanodisc shaped lipid particles. This will be similar to the α-MA lipid particle shown in FIG. 1. Lipids and sources thereof are discussed above.

### Working Examples

General Materials and Methods. All chemical reagents were obtained from commercial sources and used without further purification, unless otherwise noted.

### Synthesis

The α-olefin maleic acid copolymers are synthesized in a two step reaction according to Scheme 1 below.

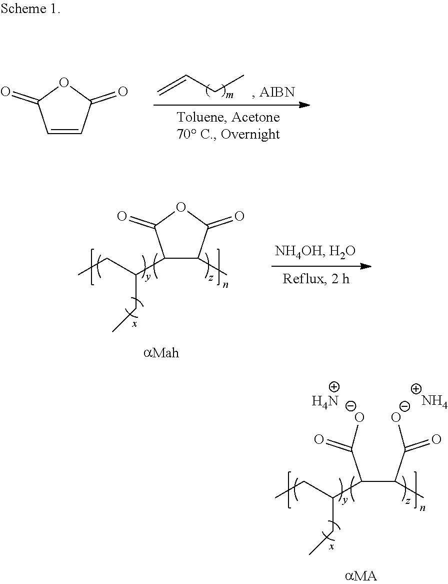

Maleic anhydride is reacted with a selected α-olefin having an R¹ selected from those discussed above, in a toluene and acetone solution with azobis isobutyronitrile (AIBN) over night at 70° C. to produce an intermediate α-olefin maleic anhydride copolymer (αMAh), which is then reflexuxed for two hours in the presence of aquous ammonium hydroxide to open the ring and form the COO.

The α-olefin-co-maleimidecopolymers are synthesized according to the reactions of Scheme 2 below.

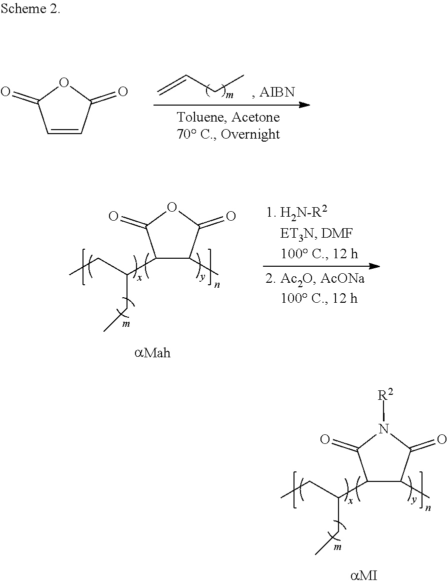

Maleic anhydride is reacted with a selected α-olefin having an R¹ selected from those discussed above, in a toluene and acetone solution with azobis isobutyronitrile (AIBN) over night at 70° C. to produce an intermediate α-olefin maleic anhydride copolymer (αMAh), which is then heated with stirring for twelve hours at 100° C. in the presence of a primary amine (H₂N—R²), triethyleamine, and dimethylformamide. Then, acetic anhydride (Ac₂O) and sodium acetate are added and the reaction vessel is heated with stirring for another twelve hours at 100° C. to for the αMI.

### Testing and Analysis

To investigate protein extraction efficiency and selectivity, each α-olefin maleic acidcopolymer was incubated with isolated Te thylakoid membranes. This resulted in the solubilization of PSI.

Preparation of Thylakoid Membranes. Thylakoid membranes were isolated following established protocols discussed in Brady et al. (noted in the background section). Briefly, Te cells were grown in BG-11 media, in an air lift, flat panel bioreactor at 45° C. (Photon Systems Instruments, Brno, Czech Republic). The cells were irradiated with about 50 μmol photons mol⁻¹ cm⁻² of light from red and white LEDs and aerated with compressed air. The cells were harvested at late log phase, pelleted at 6,000 g and re-suspended in Tris-Cl (50 mM, pH 9.5, at room temperature), with KCl (125 mM) (Buffer S) to yield 1 mg/mL chlorophyll (Chl a) solutions. The cells were then incubated at 40° C. in Buffer S with 0.0025% (w/v) lysozyme (Gold Bio, United States) for 1 h in the dark, at 250 rpm on an orbital shaker. The intact cells were then pelleted at about 10,000 g for 10 min, re-suspended in Buffer S, and Dounce-homogenized. The cells were then mechanically lysed (×10) using a benchtop LM10 microfluidizer at 23,000 psi. The intact cells and debris material were pelleted at about 10,000 g for 10 min and discarded. The thylakoid membranes contained in the supernatant were then pelleted at about 190,000 g. This pellet was resuspended using a brush and was Dounce-homogenized in Buffer S (×3) to remove membrane-associated proteins. The resultant thylakoid membranes were then diluted to 1 mg/mL chlorophyll and stored at −20° C. prior to solubilization.

Membrane Solubilization and Protein Isolation using lipid particles. Thylakoid membrane aliquots (500 μL) were incubated with an αMA in the dark at a final concentration of 1.5% (w/v) for 3 h at 40° C., while shaking (250 rpm, orbital shaker). The samples were centrifuged at about 190,000 g for 15 min and the supernatant was removed using a flame-drawn Pasteur pipette. These supernatants, which contain PSI-αMALPs, were then analyzed directly or were further purified using sucrose density gradients and ultracentrifugation.

To determine whether the chlorophyll extracted using the αMA reported herein is bound to protein complexes or free in solution, the supernatant following membrane solubilization was purified using a sucrose density gradient. This purification, sucrose density gradient centrifugation (SDGC), was conducted using a linear gradient of 10-30% (w/v) on a fixed 50% (w/v) sucrose cushion. Next, 1 mL of αMA-solubilized supernatant was loaded on top of the gradient and centrifuged in a SW-32 swinging bucket rotor for 20 h at about 150,000 g. The lowest green band was harvested using a needle syringe. This band has been shown to be PSI-αMALP. FIG. 8 is a photograph of results for the sucrose density gradients of PSI-αMALPs following solubilization with αMA copolymers, in particular C₁₄MA of various Mₙ.

With reference to FIG. 8, the box added to the photograph indicates the trimeric PSI band. Numbers to the right indicate the band number. As can be seen in FIG. 8, the top band is orange and contains liberated carotenoids (band 1). Band 2 is a diffuse green band that contains free chlorophyll, and, in the case of dodecylmaltoside (DDM), a common detergent (used as a standard for comparison), monomeric PSI and PSII. The trimeric PSI band, band 3, is noted in the box and larger PSI particles when present aggregate at the bottom of the gradient, noted as band 4. Interestingly, samples with C₁₄MA resulted in high-density chlorophyll-containing fractions dissipating in favor of higher contents of αMALPs containing single PSI trimers, see band 3. In the case of C₈MA, C₁₀MA, and C₁₂MA much less single PSQ trimers are present. Similar to DDM, the trimeric PSI is shown to be the dominant species for the C₁₄MA samples. Lastly, this side-by-side comparison allows us to observe that the αMALPs do not seem to require excess αMA in solution to maintain the integrity of the formed nanodiscs.

The trimeric PSI containing band 3 for the C₁₄MA samples was harvested from the four right-most sucrose density gradient samples in FIG. 8 for further analysis.

### Transmission Electron Microscopy.

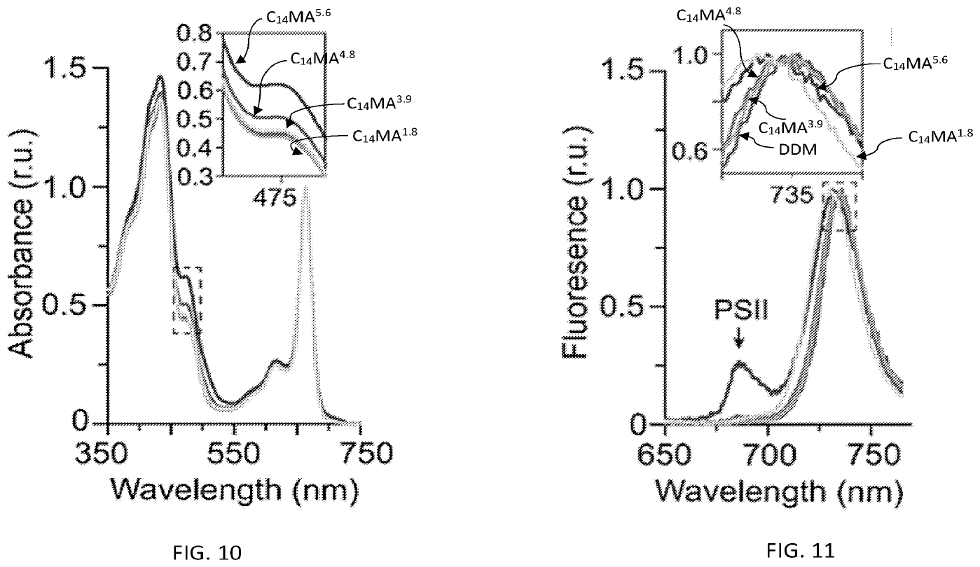

PSI-αMALPS were isolated using sucrose density gradient ultracentrifugation as discussed above. The isolated αMALP samples were diluted (×10-50) into Buffer S. A copper coated grid was placed in a 20 μL drop of the sample solution for 1 min. Excess sample was removed via filter paper absorption and the grid was washed by dipping it in distilled water. Excess distilled water was removed via filter paper absorption. The grid was then immediately stained by placing it in a 20 μL drop of 1% uranyl acetate for 1 min. The grid was allowed to dry and imaged using a JEOL 1440-Flash transmission electron microscopy (TEM), at 200 kV for visualization of the nanodiscs. FIG. 10A is a micrograph of PSI-Trimer αMALPs made with C₁₄MA^{1.8}, FIG. 10B is a micrograph of PSI-Trimer αMALPs made with C₁₄MA^{4.8}, and FIG. 10C is a micrograph of PSI-Trimer αMALPs made with C₁₄MA⁵0.6, which provides clear evidence of derivatized αMALP formation.

### Protein Analyses.

Referring now to FIG. 10, absorbance spectroscopy was performed using a dual-beam benchtop spectrophotometer (Evolution 300, ThermoScientific) on the solubilized PSI-complexes. Following solubilization and high-speed sedimentation or centrifugation, the supernatants were diluted (×20) prior to absorbance measurements. Chlorophyll was extracted with 90% methanol at 65° C. for 2 min and absorbance was taken at 665 nm to determine chlorophyll concentration. See Iwamura et al., Improved Methods for Determining Contents of Chlorophyll, Protein, Ribonucleic Acid, and Deoxyribonucleic Acid in Planktonic Populations, Internationale Revue der gesamten Hydrobiologie und Hydrographie 1970, 55 (1), 131-147 for methods of chloropyll extraction. As seen in FIG. 10, the peaks arising from carotenoids overlap in the spectral region between 425 nm and 550 nm, overlaying the Soret band for chlorophyll that is centered at 440 nm. Traces of phycocyanin (λ_{MAX}=about 625 nm), and a prominent chlorophyll absorbance peak at about 680 nm were also observed.

Next, with reference to FIG. 11, low temperature fluorescence was performed at 77 K on presumed trimeric PSI bands following sucrose density gradient ultracentrifugation using methods from Cherepanov et al., PSI-SMALP, a Detergent-free Cyanobacterial Photosystem I, Reveals Faster Femtosecond Photochemistry, Biophysical Journal 2020, 118 (2), 337-351. A PTI Quantamaster dual-channel fluorimeter (HORIBA) was used. Spectra are averaged over three measurements following background subtraction and normalized to the maximum fluorescence. Following excitation at 430 nm, free chlorophyll in solution exhibited a fluorescence at <680 nm, as well as a very minor peak at 695 nm signifying minimal extraction of PSII. The PSI-C₁₄MALPs of this working example showed very little free chlorophyll/PSII and generally displayed an F_{MAX} of 735 nm.

The results confirm that αMA copolymer lipid particles were formed that comprise a lipid from a phospholipid rich membrane or a galactolipid rich membrane. As seen in the above examples, in one embodiment, the lipid is from a galactolipid rich membrane of a cyanobacterium, but the membrane is not limited thereto. In the examples, the galactolipid-rich membrane was a cyanobacterium, more specifically, Thermosynechococcus elongatus.

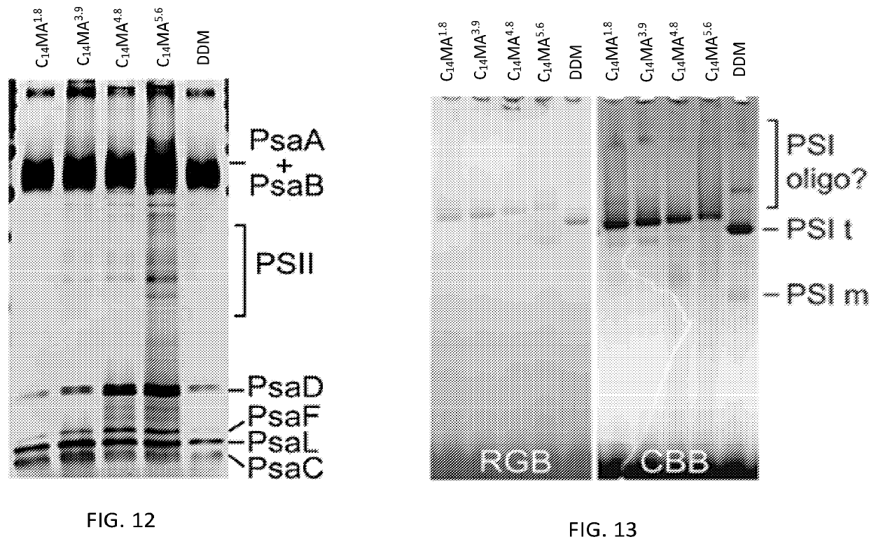

Thirdly, with reference to FIG. 12, sodium dodecyl sulfate-polyacrylamide gel (SDS-PAGE) analysis was performed using a sample solubilization buffer containing about 350 mM dithiothreitol and 4% SDS. The samples were heated in a 65° C. water bath for 9 min prior to loading onto a Bio-Rad TGX stain-free Criterion pre-cast gel. The gel was then illuminated and fixed prior to imaging of the TGX fluorochrome using a Bio-Rad ChemiDoc MP gel imaging system. The SDS-PAGE analysis separated the trimeric PSI fractions to determine their polypeptide profiles. As seen in FIG. 12, the typical PSI profile was observed for each C₁₄MA tested. PsaA+B, PsaD, Psal, PsaC, and even PsaF are each present for each trial. PsaA+B represents the non-dissociated heterodimer. The peripherally associated PsaF subunit is present in the C₁₄MA more strongly than the DDM.

Forthly, with reference to FIG. 13, blue-native PAGE analysis is presented. BN-PAGE was performed to all PSI-t isolated with copolymer and DDM (all samples corresponding to 2 μg of chlorophyll). These were loaded on a Bis-tris 3-12% gradient native gel (Bis-tris NU-PAGE, Life Technologies). Prior loading samples were mixed (10:1) with native loading buffer (50% glycerol, 50 mM Bis-tris pH 7.5, 50 mM tricine, 5% (w/v) Coomassie brilliant Blue G-250). Cathode (50 mM Bis-tris pH 7.5, 50 mM tricine and 0.1% Coomassie brilliant Blue G-250) and anode buffer (50 mM Bis-tris pH 7.5, 50 mM tricine) were used for running the gel at 60V for 15 h at 4° C. Gels were then RGB scanned and then stained with Coomassie G-250. As seen in FIG. 13, the predominant species of protein isolated was trimeric-PSI.

### Results and Discussion.

Turning now to FIG. 2, to quantify the percent solubilization efficiency (SE) of extracted chlorophyll proteins of each αMA, we compared extracted chlorophyll in the supernatant to the 1 mg/mL chlorophyll of the starting thylakoid membrane and reported this as a percentage. Quantification of this data confirms that: α-olefin maleic acid copolymers are excellent at solubilizing chlorophyll-containing pigment protein complexes from Te. These copolymers could be important amphiphilic polymers for the detergent-free extraction of proteins from many systems. According to FIG. 2, the polymer solutions of 2.5 wt % afforded the highest amount of extracted PSI; thus, all further extractions were performed at this concentration and were normalized with respect to DDM. These two aspects of the procedure ensure consistent testing and data that can be compared across different batches of Te membrane.

Next, with reference to FIG. 3, the molecular weight of the polymer was controlled to determine the affect of molecular weight on the protein extraction process. For this experiment, four C₁₄MA samples were synthesized, featuring molecular weights ranging from 1.8 kg/mol to 5.6 kg/mol (as denoted by the superscript in the polymer identifier). It was found that samples having around 3.9 kg/mol to 4.8 kg/mol appear to have the highest solubilization efficiency. The data for FIG. 3 is set forth below in Table 1.

TABLE 1

| | Average | Std. Dev. | Lipid | Poly Mₙ | |
|---|---|---|---|---|---|
| | (nm) | (nm) | (nmol/g) | (kg/mol) | Ð |
| C₁₄MA | 34.0 | 15.8 | — | 3.7 | 2.1 |
| C₁₄MA^{1·8} | 38.8 | 21.7 | 473.1 | 1.8 | 1.6 |
| C₁₄MA^{3·9} | 35.2 | 18.6 | 113.5 | 3.9 | 1.3 |
| C₁₄MA^{4·8} | 28.8 | 12.6 | 103.9 | 4.8 | 1.4 |
| C₁₄MA^{5·}6 | 33.1 | 11.6 | 218.5 | 5.6 | 1.4 |

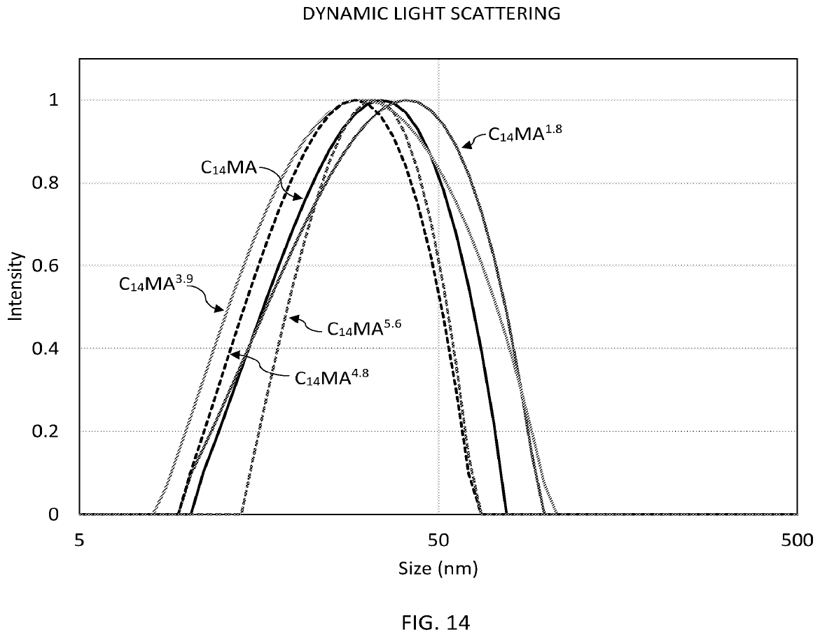

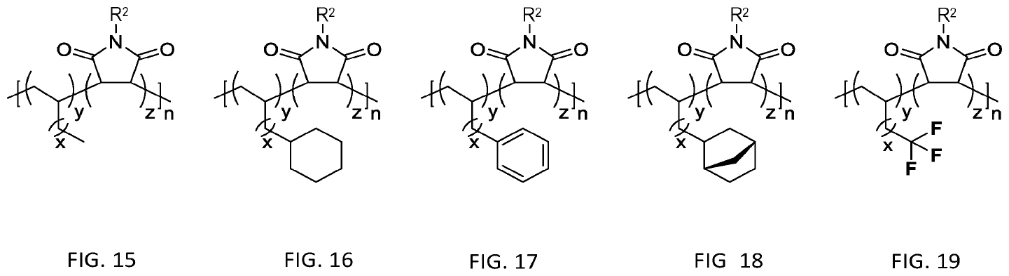

Referring now to Table 2 below and FIG. 14, after the protein complexes within the isolated αMALPS were fully characterized, the nanodiscs themselves could be characterized. Each of the PSI-αMALPS formed with the C₁₄MA molecular weight series were sent off for lipidomics. This process confirmed that all nanodiscs had a much higher level of lipid content than protein complexes isolated using detergents (see Table 2 below) suggesting the formation of protein-containing lipid nanodiscs rather than micelles containing only protein and no lipids.

TABLE 2

| | Average | Std. Dev. | Lipid | Poly Mₙ | |
|---|---|---|---|---|---|
| | (nm) | (nm) | (nmol/g) | (kg/mol) | Ð |
| C₁₄MA | 34.0 | 15.8 | — | 3.7 | 2.1 |
| C₁₄MA^{1·8} | 38.8 | 21.7 | 473.1 | 1.8 | 1.6 |
| C₁₄MA^{3·9} | 35.2 | 18.6 | 113.5 | 3.9 | 1.3 |
| C₁₄MA^{4·8} | 28.8 | 12.6 | 103.9 | 4.8 | 1.4 |
| C₁₄MA^{5.6} | 33.1 | 11.6 | 218.5 | 5.6 | 1.4 |

Further, the isolated PSI-αMALPS were subjected to dynamic light scattering (DLS) to probe the size distribution of nanodisc species, as seen in FIG. 14. Every sample tested formed discs in the expected size range of 20-50 nm.

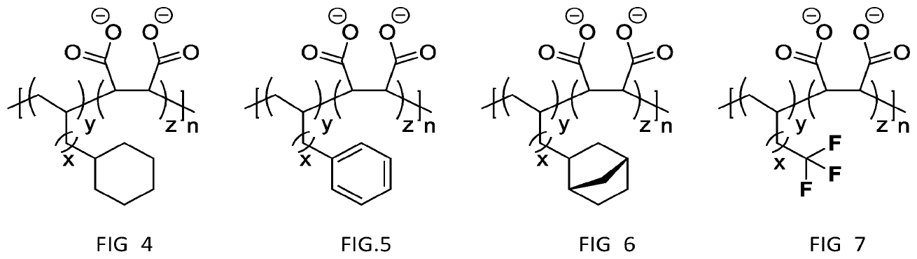

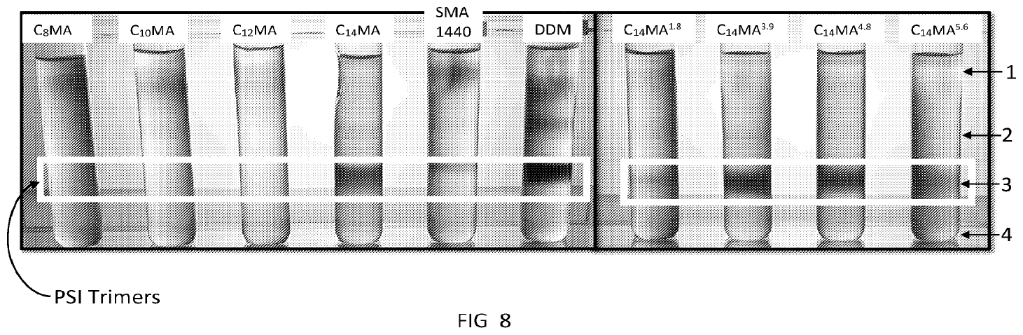

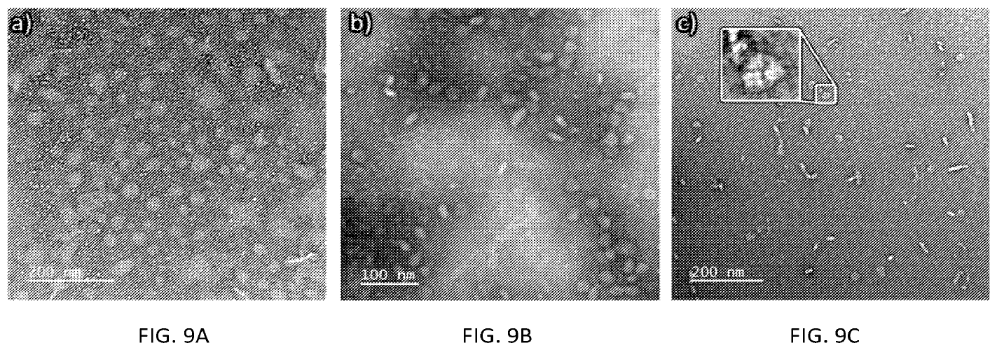

αMAs have proven to be excellent at solubilizing chlorophyll-containing pigment protein complexes from Te and could go on to be incredibly important amphiphilic polymers for the detergent-free extraction of proteins from many systems. In addition to having increased bioactivity, αMAs are cheap to synthesize, easily purified, are not susceptible to degradation via saponification, and don't absorb in the UV range. All of these properties make αMAs extremely promising as the future of the amphiphilic polymer protein extraction field. To expand on these polymers, we have designed even more αMAs analogs that are currently being investigated (FIG. 4). These polymers feature a variety of structural changes that we hope to leverage to gain insight into the protein extraction process. In the future, this insight could lead to the design of αMAs, or other amphiphilic copolymers, for the targeted extraction of specific proteins.

We have synthesized and characterized α-olefin maleic acid copolymers and α-olefin-co-malemide copolymers that have dramatically improved bioactivity. The copolymers are cheap to synthesize in a two-step reaction, are easily purified, are not susceptible to degradation via saponificiation, and don't absorb UV wavelengths (e.g., 100 to 400 nm). All of these properties make these copolymers extremely promising as the future of the amphiliic polymer protein extraction field. Both types of copolymers will have applications in the following non-limiting example industries: pharmaceutical, bioenergy, protein isolation, drug delivery, and food.

Reactivity ratio studies have found that the αMA are highly alternating, with a slight bias towards higher incorporations of maleic anhydride (usually 1.1-1.3:1 maleic anhydride: 1-alkene). C₁₄MA has elicited the highest solubilization efficiency for extracting proteins from Te that has been reported for any amphiphilic copolymer, extracting nearly 80% of the total chlorophyll-containing pigment protein complexes in some trials (FIG. 2).

It should be noted that the embodiments are not limited in their application or use to the details of construction and arrangement of parts and steps illustrated in the drawings and description. Features of the illustrative embodiments, constructions, and variants may be implemented or incorporated in other embodiments, constructions, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

Having described the invention in detail and by reference to preferred embodiments thereof, it will be apparent that modifications and variations are possible without departing from the scope of the invention which is defined in the appended claims.

1. An α-olefin modified maleic acid copolymer comprising:
a general formula I 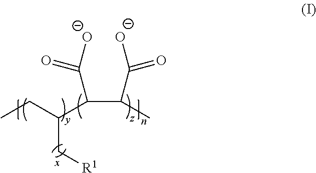
wherein x is in a range of 1 to 19; y and z have a ratio in a range of 0.25:1 to 8:1; n yields a copolymer having an average molecular weight of less than 500 kg/mol; and R¹ is selected from the group consisting of
i. a linear alkane chain, optionally, containing or terminating with a cyclic carbon,
xi. a linear chain alkoxy alkane of the formula —(CH₂)_{q}O(CH₂)ᵣCH₃ where q is 1 to 5 and r is 1 to 15,
xii. an alkoxy alkane containing or terminating with a cyclic carbon chain,
xiii. a halogenated alkane,
xiv. a halogenated cycloalkane,
xv. a halogenated arene,
xvi. a chain containing a repeating sequence of (CH₂CH₂O)ₜ terminating with —OR² wherein t equals a value of 1 to 50 and R² is hydrogen, a linear alkane, a cyclic alkane, a trifluoromethyl, a halogenated alkane, a halogenated cycloalkane, or a halogenated arene,
xvii. a hydrogen, and
xviii. mixtures thereof.

2. The α-olefin maleic acid copolymer of claim 1, wherein x is 5, 7, 9, 11, or 13.

3. The α-olefin maleic acid copolymer of claim 1, wherein x is 11 and R¹ is a methyl.

4. The α-olefin maleic acid copolymer of claim 3, wherein the average molecular weight is greater than 2 kg/mol but less than 6 kg/mol.

5. The α-olefin maleic acid copolymer of claim 1, wherein the halogenated alkane is trifluoromethyl.

6. The α-olefin maleic acid copolymer of claim 1, wherein R¹ is one or more of a methyl, a cyclohexane, a benzyl, a norbornyl, or a trifluoromethyl group.

7. The α-olefin maleic acid copolymer of claim 1, wherein y and z have a ratio of 1:1.2.

8. A α-olefin maleic acid copolymer lipid particle comprising:
a lipid from a phospholipid rich membrane or a galactolipid rich membrane- and a modified maleic acid copolymer comprising:
a general formula I 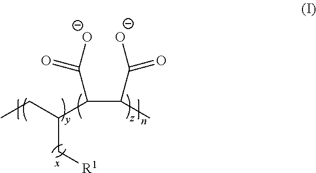
wherein x is in a range of 1 to 19; y and z have a ratio in a range of 0.25:1 to 8:1; n yields a copolymer having an average molecular weight of less than 500 kg/mol; and R¹ is selected from the group consisting of
ii. an alkane chain, optionally, containing or terminating with a cyclic carbon,
xix. a linear chain alkoxy alkane of the formula —(CH₂)_{q}O(CH₂)ᵣCH₃ where q is 1 to 5 and r is 1 to 15,
xx. an alkoxy alkane containing or terminating with a cyclic carbon chain,
xxi. a halogenated alkane,
xxii. a halogenated cycloalkane,
xxiii. a halogenated arene,
xxiv. a chain containing a repeating sequence of (CH₂CH₂O)ₜ terminating with —OR² wherein t equals a value of 1 to 50 and R² is hydrogen, a linear alkane, a cyclic alkane, a trifluoromethyl, a halogenated alkane, a halogenated cycloalkane, or a halogenated arene,
xxv. a hydrogen, and
xxvi. mixtures thereof:
or a general formula II 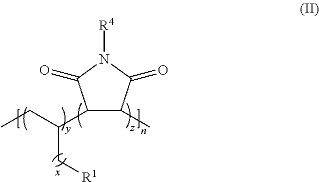
wherein x is in a range of 1 to 19; y and z have a ratio in a range of 0.25:1 to 8:1; n yields a copolymer having an average molecular weight of less than 500 kg/mol; and R¹ and R⁴ are both selected from the group consisting of
i. a linear alkane chain, optionally, containing or terminating with a cyclic carbon,
ii. a linear chain alkoxy alkane of the formula —(CH₂)_{q}O(CH₂)ᵣCH₃ where q is 1 to 5 and r is 1 to 15,
iii. an alkoxy alkane containing or terminating with a cyclic carbon chain,
iv. a halogenated alkane,
v. a halogenated cycloalkane,
vi. a halogenated arene,
vii. a chain containing a repeating sequence of (CH₂CH₂O)ₜ terminating with —OR⁵ wherein t equals a value of 1 to 50 and R⁵ is hydrogen, a linear alkane, a cyclic alkane, a trifluoromethyl, a halogenated alkane, a halogenated cycloalkane, or a halogenated arene,
viii. a hydrogen, and
ix. mixtures thereof, and
R¹ and R⁴ are the same or different.

9. The α-olefin maleic acid copolymer lipid particle of claim 8, wherein the lipid is from a galactolipid rich membrane of a cyanobacterium.

10. The α-olefin maleic acid copolymer lipid particle of claim 9, wherein the cyanobacterium is Thermosynechococcus elongatus.

11. An α-olefin-co-maleimide copolymer comprising:
a general formula II 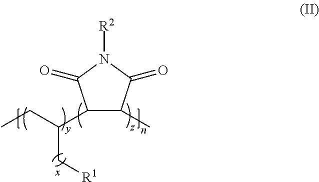
wherein x is in a range of 1 to 19; y and z have a ratio in a range of 0.25:1 to 8:1; n yields a copolymer having an average molecular weight of less than 500 kg/mol; and R¹ and R² are both selected from the group consisting of
x. a linear alkane chain, optionally, containing or terminating with a cyclic carbon,
xi. a linear chain alkoxy alkane of the formula —(CH₂)_{q}O(CH₂)ᵣCH₃ where q is 1 to 5 and r is 1 to 15,
xii. an alkoxy alkane containing or terminating with a cyclic carbon chain,
xiii. a halogenated alkane,
xiv. a halogenated cycloalkane,
xv. a halogenated arene,
xvi. a chain containing a repeating sequence of (CH₂CH₂O)ₜ terminating with —OR² wherein t equals a value of 1 to 50 and R² is hydrogen, a linear alkane, a cyclic alkane, a trifluoromethyl, a halogenated alkane, a halogenated cycloalkane, or a halogenated arene,
xvii. a hydrogen, and
xviii. mixtures thereof, and
R¹ and R² are the same or different.

12. The α-olefin-co-maleimide copolymer of claim 11, wherein x is 5, 7, 9, 11, or 13.

13. The α-olefin-co-maleimide copolymer of claim 11, wherein x is 11 and R¹ is a methyl.

14. The α-olefin-co-maleimide copolymer of claim 13, wherein the average molecular weight is greater than 2 kg/mol but less than 6 kg/mol.

15. The α-olefin-co-maleimide copolymer of claim 11, wherein the halogenated alkane is trifluoromethyl.

16. The α-olefin-co-maleimide copolymer of claim 11, wherein R¹ is one or more of a methyl, a cyclohexane, a benzyl, a norbomyl, or a trifluoromethyl group.

17. The α-olefin-co-maleimide copolymer of claim 11, wherein y and z have a ratio of 1:1.2.

18-20. (canceled)

21. The α-olefin maleic acid copolymer lipid particle of claim 8, wherein x is 5, 7, 9, 11, or 13.

22. The α-olefin maleic acid copolymer lipid particle of claim 21, wherein x is 11, and R¹ is a methyl.

23. The α-olefin maleic acid copolymer lipid particle of claim 8, wherein R¹ is one or more of a methyl, a cyclohexane, a benzyl, a norbornyl, or a trifluoromethyl group.
